(19) United States
(12) Patent Application Publication
(10) Pub. No.: US 2026/0367998 A1
(43) Pub. Date: Nov. 19, 2026

(54) MANAGING POWER CONSUMPTION IN A PROCESSOR-BASED SYSTEM USING PERFORMANCE LIMIT REGISTER(S) SUPPORTING A COMBINED PERFORMANCE STATE LIMIT AND CURRENT CONSUMPTION LIMIT

(71) Applicant: Microsoft Technology Licensing, LLC, Redmond, WA (US)

(72) Inventors: Serena BADRAN-LOUCA, Raleigh, NC (US); Timothy F. PHILLIPS, Fuquay-Varina, NC (US); Saharsh PARAKH, Raleigh, NC (US); Richard Gerard HOFMANN, Cary, NC (US)

(21) Appl. No.: 19/209,635

(22) Filed: May 15, 2025

(51) Int. Cl. G05F 1/565; G05F 1/70

(52) U.S. Cl. CPC G05F 1/565; G05F 1/70

(57) ABSTRACT

Managing power consumption in a processor-based system using performance limit register(s) supporting a combined performance state limit and current consumption limit. The processor-based system includes a power management system configured to manage power consumption of processor cores (“cores”) to maintain overall power consumption of the processor-based system with a desired power limit(s). The power management system is configured to write both a determined performance state limit and a determined current consumption limit for each processor core to a respective performance limit register with a single write operation that is used by the processor core to control its power consumption. Providing a performance limit register that supports a combined performance state limit and current consumption limit avoids latency between the power management system providing an updated performance state limit and an updated current consumption limit, which may not allow the cores to be as effective in controlling their power consumption.

### FIELD OF THE DISCLOSURE

The technology of the disclosure relates generally to power management in a processor-based system to maintain the processor-based system with a desired power limit.

### BACKGROUND

Processing units (PUs) perform computational tasks for a wide variety of applications. A PU includes a processor that includes one or more processor cores (also referred to as just “cores”). The processor cores are configured to execute software/firmware instructions (“instructions”) to perform tasks. The PU may be included in an integrated circuit (IC) as a system-on-a-chip (SoC) that combines multiple PUs with other support computing components (e.g., memory, input/output ports, etc.). An SoC may integrate several different PUs (e.g., a central processing unit (CPU), a graphic processing unit (GPU), a neural processing unit (NPU)), memory controllers, and other specialized modules (like artificial intelligence (AI) or multimedia accelerators) on one or more dies, creating compact and powerful PUs. This can increase efficiency, reduce power consumption, and enable faster data transfer across such components. Mesh networks are also provided in an SoC to allow for seamless data communication among processor cores and different computing devices, thus reducing latency and increasing bandwidth. The mesh network includes a plurality of routing circuits (also referred to as “nodes” or “routers”) that are each connected to several routing circuits in a grid-like pattern, enabling direct communication between components without needing to go through a central bus or hub, thereby optimizing data transfer. The routers receive data in the form of data packets from processor cores (or other peripheral circuitry) and then transfer such data packets to other processor cores or peripheral circuitry in the mesh network.

It is desired to provide power management in a processor-based system, such as an SoC, to ensure that overall power consumption in the processor-based system does not exceed design power limits. For example, the processor-based system may have design power limits based on a power limit that would degrade performance and/or risk damage to circuitry in the processor-based system. However, it also desired to enhance performance of a PU and its processor cores of the processor-based system by increasing operating frequency and/or voltage level used to operate the processor cores. As is well known, within operational limits, increasing frequency and/or voltage level used to operate a processor and/or its processor cores increases its processor performance. However, increasing frequency and voltage level also increases current consumption, which in turn increases overall power consumption in the processor-based system. Thus, a power management system provided in a processor-based system may be configured to determine power budgets for each of the processor cores in the processor-based system to ensure that the power consumption of the processor cores can keep the overall power consumption of the processor-based system within desired limits. In this regard, the power management system can be configured to control power consumption of the processor cores by controlling a performance state (e.g., operating frequency and/or voltage) for each of the processor cores according to a determined power budget for the processor cores. The power budgets for the processor cores can be determined and allocated to the processor cores based on respective requested performance levels from the processor cores and the relative priorities of the workloads executed by the processor cores, in relation to an overall system power budget for the processor-based system. The power management system can then control the performance state of the processor cores based on the determined power budgets for the processor cores. In this manner, performance of the processor cores is enhanced when possible while keeping the overall power consumption of the processor-based system within desired limits.

While a performance state of a processor core affects its power consumption, the performance state of a processor core does not accurately control current consumption by the processor core. Current consumption of a processor core is not only affected by its performance state, but it is also affected by the particular workload being executed by the processor core. Each workload has a unique combination of instructions that affect when and how circuitry in the processor core is activated as well as its power consumption. Thus, even with controlling the performance states of processor cores in a processor-based system, power consumption of the processor cores that contribute to the overall power consumption of the processor-based system may not still be fully accurately controlled. One way to solve this issue is to control setting of performance states in the processor cores to allow for a worse case current consumption for a given performance state. However, this can sacrifice a processor core reaching a maximum performance level at times when a higher performance state is possible when the overall power consumption of the processor-based system would remain within its power limit.

### SUMMARY

Exemplary aspects disclosed herein include managing power consumption in a processor-based system using performance limit register(s) supporting a combined performance state limit and current consumption limit. The processor-based system includes a processing unit (PU) that includes one or more processor cores (“cores”) that can each execute computer program instructions to perform tasks. The processor-based system may be provided as a system-on-a-chip (SoC) as an example, wherein the PU is incorporated into a single integrated circuit (IC) chip along with other supporting computing components (e.g., memory, communications buses, input/output ports, etc.). The processor-based system includes a power management system configured to manage power consumption of the processor cores to maintain the overall power consumption of the processor-based system with a desired power limit(s). In this regard, the power management system is configured to determine and allocate local power budgets for each of the processor cores relative to an overall system power budget for the processor-based system to optimize performance in the processor-based system, but within the overall power limit of the processor-based system. The local power budgets for the processor cores can be determined based on respective requested performance states (i.e., operating frequency and/or operating voltage) from the processor cores themselves as well as their relative workload priorities. The power management system communicates respective performance state limits to performance control circuits each assigned to a particular processor core based on the determined local power budgets for the processor cores. The performance control circuits are each configured to cause its assigned processor core to operate within a determined performance state limit. Each performance control circuit uses its performance state limit to control the performance state (i.e., operating frequency and/or operating voltage) of its assigned processor core. If the desired performance state fora given processor core exceeds its performance state limit, the performance control circuit enforces the performance state limit from the performance limit register as its assigned processor core's performance state. When the desired performance state for a given processor core is less than its performance state limit, the performance control circuit allows its assigned processor core to operate according to desired performance state to conserve power.

However, while a performance state of a processor core affects its power consumption, the actual power consumption by a processor core can vary according to its executed workload. In this regard, in exemplary aspects, the power management system is also configured to determine and communicate current consumption limits for the processor cores based on the respective allocated local power budgets to the processor cores. The performance control circuits each include or are associated with respective current measurement circuits that are configured to measure actual current consumption by its assigned processor core. The performance control circuits are configured to lower the performance state of their assigned processor core even below the performance state limit for its assigned processor core if the actual current consumption of its assigned processor core exceeds the current consumption limit for its assigned processor core. In this manner, the power management system is not only configured to control performance states of the processor cores to optimize performance level for a given local power budget, but is also configured to precisely control power consumption in the processor cores by limiting both their performance state and current consumption.

In further exemplary aspects, to provide a mechanism to communicate performance state limits for the individual processor cores to be used to control their maximum performance state, a performance limit register is provided for each performance control circuit in the processor-based system. The performance limit register for each performance control circuit is written by the power management system with the determined performance state limit for its assigned processor core. In exemplary aspects, to avoid the need to provide a separate current consumption register to store a respective current consumption limit for each processor core, the performance limit registers are configured to store both a performance state limit and a current consumption limit for its assigned processor core. In this regard, the power management system can write both a determined performance state limit and a determined current consumption limit for each processor core to its assigned respective performance limit register with a single write operation, as opposed to having to use multiple write operations to multiple registers. Providing a performance limit register that supports a combined performance state limit and current consumption limit for the processor cores can avoid latency between the power management system providing an updated performance state limit and an updated current consumption limit for a given processor core. This is because performance limit register supports storage of both a performance state limit and current consumption limit with a single write operation. If multiple separate registers had to be written through multiple write operations to provide a performance state limit and current consumption limit for a given processor core, the processor core may not be as effective in controlling power consumption as required by the power management system.

For example, for a given processor core, if two separate performance state and current consumption limit registers were provided, the resulting added latency between first writing an updated, lower performance state to the performance state register followed by separately writing a subsequent updated, decreased current consumption limit, could cause a processor core to initially operate at the new, updated lower performance state before the current consumption limit could be reduced to the new, decreased current consumption limit. This would risk the processor core not throttling current consumption as desired according to the new lower performance state, thus cause the processor core to possibly exceed its local power budget set by the power management system. Also, as another example, if two separate performance state and current consumption limit registers were provided, the resulting added latency between first writing an updated, higher performance state to the performance state register followed by a subsequent updated, increased current consumption limit, could cause a processor core to initially operate at the higher performance state before the current consumption limit could be increased to the new, increased current consumption limit. This could cause current consumption to be unnecessarily throttled in the processor core and thus possibly reduce its performance needlessly even when its allocated local power budget would allow for higher current consumption.

In other exemplary aspects, the performance limit registers that support a combined performance state limit and current consumption limit can be configured to support one current consumption limit or multiple current consumption limits. For example, if a single current consumption limit is supported, and the current consumption by a given processor core is determined to exceed such current consumption limit, the performance control circuit assigned to the processor core could be configured to reduce the performance state of the processor core, and then again set the performance state to that called for in its performance limit register when current consumption falls back below the single current consumption limit.

As another example, if multiple current consumption limits are supported, each current consumption limit can be used to support a different performance state action for the processor core to manage its current consumption while also trying to optimize performance. For example, if current consumption of a given processor core is determined to exceed a highest current consumption limit among multiple current consumption limits, the performance control circuit associated with the processor core could be configured to reduce the performance state of the processor core by multiple performance levels (i.e., multiple voltage and/or frequency steps) to reduce current consumption in the processor core. In another example, if current consumption of a given processor core is determined to not exceed a lowest current consumption limit among multiple current consumption limits, the performance control circuit associated with the processor core could be configured to maintain the current performance state of the processor core as called for in its associated performance limit register. In another example, if current consumption of a given processor core is determined to exceed an intermediate current consumption limit among multiple current consumption limits, but not exceed the highest current consumption limit, the performance control circuit associated with the processor core could be configured to lower the current performance state of the processor core by a single performance level (i.e., one voltage and/or frequency step). In yet another example, if the current consumption of a given processor core is determined to lower back below the intermediate current consumption limit as a result of limiting performance state, the performance control circuit associated with the processor core could be configured to not lower the performance state of the processor core back to the performance state called for in its performance limit register until the current consumption of the processor core falls back below the lowest current consumption limit.

In other exemplary aspects, in addition to the power management circuit being configured to receive the desired performance state and/or priority of the processor cores for determining local power budgets and related performance state and current consumption limit for the processor cores, the power management circuit can also be configured to communicate any confirmed performance state change of the processor cores. The power management circuit can use the acknowledgement of confirmed performance state changes as knowing the actual performance states in the processor cores to then use this information for allocating updated local power budgets, as needed or necessary. The power management circuit may also be configured to control a supply voltage provided to the processor cores based on an acknowledged change in performance state in a processor core(s). In exemplary aspects, each performance control circuit may be configured to control a voltage regulator circuit that can be controlled to limit the supply voltage according to a performance state. However, the performance control circuits may not be configured to control the supply voltage. Thus, in this example, the power management circuit is configured to change the supply voltage provided to the processor cores, as needed, to be compatible with any confirmed performance state change in the processor cores so that the supply voltage is compatible with the performance state in the processor cores. For example, if the performance state is increased in a processor core, the power management circuit may need to increase the supply voltage provided to the processor core so that the increased performance state can be achieved. There is a positive correlation between supply voltage and operating frequency that can be achieved in a processor core. As another example, if the performance state of a processor core is limited due to exceeding its performance state limit or its current consumption exceeding its current consumption limits, in response to such notification, the power management circuit may be configured to lower the supply voltage provided to the processor cores to conserve power while still providing a supply voltage that is compatible with the limited performance state.

In this regard, in one exemplary aspect, a processor-based system is provided. The processor-based system comprises a plurality of processor cores. The processor-based system also comprises a plurality of performance limit registers each associated with an assigned processor core of the plurality of processor cores. Each performance limit register of the plurality of performance limit registers is configured to store a performance state limit and a current consumption limit. The processor-based system also comprises a power management circuit configured to, for each processor core of the plurality of processor cores: determine a local power budget for the processor core based on a system power budget in the processor-based system; determine a performance state limit and a current consumption limit for the processor core based on a determined local power budget for the processor core; and write the determined performance state limit and the current consumption limit for the processor core to the performance limit register of the plurality of performance limit registers associated with the processor core. The processor-based system also comprises a plurality of performance control circuits each associated with an assigned processor core of the plurality of processor cores. Each performance control circuit of the plurality of performance control circuits is configured to: control a performance state of its assigned processor core according to a current performance state for its assigned processor core; determine whether the current performance state of its assigned processor core exceeds the performance state limit in the performance limit register for its assigned processor core, and in response to determining that the current performance state of its assigned processor core exceeds the performance state limit in the performance limit register for its assigned processor core, update the current performance state of its assigned processor core to the performance state limit; determine whether current consumption of its assigned processor core exceeds the current consumption limit in the performance limit register for its assigned processor core; and in response to determining that the current consumption of its assigned processor core exceeds the current consumption limit in the performance limit register for its assigned processor core, throttle the current performance state of its assigned processor core to a new performance state lower than the current performance state.

In another exemplary aspect, a method of managing power consumption of a plurality of processor cores in a processor in a processor-based system is provided. The method comprises, for each processor core of the plurality of processor cores: determining a local power budget for the processor core based on a system power budget in the processor-based system; determining a performance state limit and a current consumption limit for the processor core based on a determined local power budget for the processor core; writing the determined performance state limit and the current consumption limit for the processor core to a performance limit register of a plurality of performance limit registers associated with the processor core; controlling a performance state of the processor core according to a current performance state for the processor core; determining whether the current performance state of the processor core exceeds the performance state limit in the performance limit register for the processor core; in response to determining that the current performance state of the processor core exceeds the performance state limit in the performance limit register for the processor core, updating the current performance state of the processor core to the performance state limit; determining whether current consumption of the processor core exceeds the current consumption limit in the performance limit register associated with the processor core; and in response to determining that the current consumption of the processor core exceeds the current consumption limit in the performance limit register associated with the processor core, throttling the current performance state of the processor core to a new performance state lower than the current performance state.

In another exemplary aspect, a non-transitory computer-readable medium having stored thereon computer executable instructions, which when executed by a processor in a processor-based system comprising a plurality of processor cores, causes the processor to: for each processor core of the plurality of processor cores: determine a local power budget for the processor core based on a system power budget in the processor-based system; determine a performance state limit and a current consumption limit for the processor core based on a determined local power budget for the processor core; write the determined performance state limit and the current consumption limit for the processor core to a performance limit register of a plurality of performance limit registers associated with the processor core; control a performance state of the processor core according to a current performance state for the processor core; determine whether the current performance state of the processor core exceeds the performance state limit in the performance limit register for the processor core; in response to determining that the current performance state of the processor core exceeds the performance state limit in the performance limit register for the processor core, update the current performance state of the processor core to the performance state limit; determine whether current consumption of the processor core exceeds the current consumption limit in the performance limit register associated with the processor core; and in response to determining that the current consumption of the processor core exceeds the current consumption limit in the performance limit register associated with the processor core, throttle the current performance state of the processor core to a new performance state lower than the current performance state.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram of an exemplary processor-based system that includes a central processing unit (CPU) that includes a plurality of processor cores (“cores”), and a power management system that includes a power management circuit configured to write a determined performance state limit and determined current consumption limit to a performance limit register for each core, and wherein a performance control circuit in each core as part of the power management system is configured to limit its core performance state based on its performance state limit and current consumption limit set by the power management circuit;

FIG. 2 is a workload power graph illustrating exemplary different power consumption levels in a processor core that can exist for the same performance level based on varying workloads;

FIG. 3 is a block diagram illustrating more exemplary detail of the cores in the processor-based system in FIG. 1, wherein the cores each include a performance limit register configured to be written by the power management circuit in FIG. 1 with a performance state limit and a current consumption limited determined for the core, and a performance control circuit configured to limit its core performance state based on the performance state limit and current consumption limit in its performance limit register;

FIG. 4 is a block diagram illustrating more exemplary detail of a telemetry data system in the processor-based system in FIG. 1 that includes telemetry producer circuits configured to transmit telemetry data in telemetry data packets for its associated core onto the internal communication network, including requested performance data including a requested performance state, in telemetry data packets to be received by the power management circuit;

FIG. 5A is a block diagram illustrating more exemplary detail of the internal communication network in the processor-based system in FIGS. 1 and 3-4;

FIG. 5B is a diagram illustrating exemplary detail of a network node in the internal communication network in FIG. 5A, wherein the network node is configured to forward data packets to the power management circuit in the processor-based system in FIGS. 1 and 3-4;

FIGS. 6A and 6B is a flowchart illustrating an exemplary core performance management process of a performance control circuit in a core in a processor-based system, including the performance control circuits in the processor-based system in FIGS. 1 and 3-4, controlling its performance state based on a performance state limit written and current consumption limit written into a single performance limit register;

FIG. 7 is a block diagram illustrating exemplary detail of a performance control circuit in the form of a dynamic voltage frequency scaling (DVFS) circuit that can be provided for an assigned core in FIGS. 1 and 3, wherein the DVFS circuit is configured to control its performance state based on the performance state limit written in its performance limit register and also further to control its performance state based on a comparison of the actual current consumption in the core to the current consumption limit written to the performance limit register;

FIG. 8 is a block diagram of an exemplary performance limit register that can be assigned for each core in the processor-based system in FIGS. 1 and 3-4;

FIG. 9 is a flowchart illustrating an exemplary power management process of a power management circuit in a processor-based system, including the power management circuit in the processor-based system in FIGS. 1 and 4, determining performance state limit and current consumption limit for each core based on a determined local power budget for each core, and writing the determined performance state limit and current consumption limit for each core into its respective performance limit register; and

FIG. 10 is a block diagram of another exemplary processor-based system that can be the processor-based system in FIGS. 1, 3-4, and 7, wherein the processor-based system includes a plurality of processor cores (“cores”), and an exemplary power management system configured to write a determined performance state limit and determined current consumption limit to a performance limit register for each core, and configured to limit the performance state of each based on its respective performance state limit and current consumption limit written to the respective performance limit register assigned to the core, including according to, but not limited to, the processes in FIGS. 6A, 6B, and 9.

### DETAILED DESCRIPTION

Exemplary aspects disclosed herein include managing power consumption in a processor-based system using performance limit register(s) supporting a combined performance state limit and current consumption limit. The processor-based system includes a processing unit (PU) that includes one or more processor cores (“cores”) that can each execute computer program instructions to perform tasks. The processor-based system may be provided as a system-on-a-chip (SoC) as an example, wherein the PU is incorporated into a single integrated circuit (IC) chip along with other supporting computing components (e.g., memory, communications buses, input/output ports, etc.). The processor-based system includes a power management system configured to manage power consumption of the processor cores to maintain the overall power consumption of the processor-based system with a desired power limit(s). In this regard, the power management system is configured to determine and allocate local power budgets for each of the processor cores relative to an overall system power budget for the processor-based system to optimize performance in the processor-based system, but within the overall power limit of the processor-based system. The local power budgets for the processor cores can be determined based on respective requested performance states (i.e., operating frequency and/or operating voltage) from the processor cores themselves as well as their relative workload priorities. The power management system communicates respective performance state limits to performance control circuits each assigned to a particular processor core based on the determined local power budgets for the processor cores. The performance control circuits are each configured to cause its assigned processor core to operate within a determined performance state limit. Each performance control circuit uses its performance state limit to control the performance state (i.e., operating frequency and/or operating voltage) of its assigned processor core. If the desired performance state fora given processor core exceeds its performance state limit, the performance control circuit enforces the performance state limit from the performance limit register as its assigned processor core's performance state. When the desired performance state for a given processor core is less than its performance state limit, the performance control circuit allows its assigned processor core to operate according to desired performance state to conserve power.

However, while a performance state of a processor core affects its power consumption, the actual power consumption by a processor core can vary according to its executed workload. In this regard, in exemplary aspects, the power management system is also configured to determine and communicate current consumption limits for the processor cores based on the respective allocated local power budgets to the processor cores. The performance control circuits each include or are associated with respective current measurement circuits that are configured to measure actual current consumption by its assigned processor core. The performance control circuits are configured to lower the performance state of their assigned processor core even below the performance state limit for its assigned processor core if the actual current consumption of its assigned processor core exceeds the current consumption limit for its assigned processor core. In this manner, the power management system is not only configured to control performance states of the processor cores to optimize performance level for a given local power budget, but is also configured to precisely control power consumption in the processor cores by limiting both their performance state and current consumption.

In further exemplary aspects, to provide a mechanism to communicate performance state limits for the individual processor cores to be used to control their maximum performance state, a performance limit register is provided for each performance control circuit in the processor-based system. The performance limit register for each performance control circuit is written by the power management system with the determined performance state limit for its assigned processor core. In exemplary aspects, to avoid the need to provide a separate current consumption register to store a respective current consumption limit for each processor core, the performance limit registers are configured to store both a performance state limit and a current consumption limit for its assigned processor core. In this regard, the power management system can write both a determined performance state limit and a determined current consumption limit for each processor core to its assigned respective performance limit register with a single write operation, as opposed to having to use multiple write operations to multiple registers. Providing a performance limit register that supports a combined performance state limit and current consumption limit for the processor cores can avoid latency between the power management system providing an updated performance state limit and an updated current consumption limit for a given processor core. This is because performance limit register supports storage of both a performance state limit and current consumption limit with a single write operation. If multiple separate registers had to be written through multiple write operations to provide a performance state limit and current consumption limit for a given processor core, the processor core may not be as effective in controlling power consumption as required by the power management system.

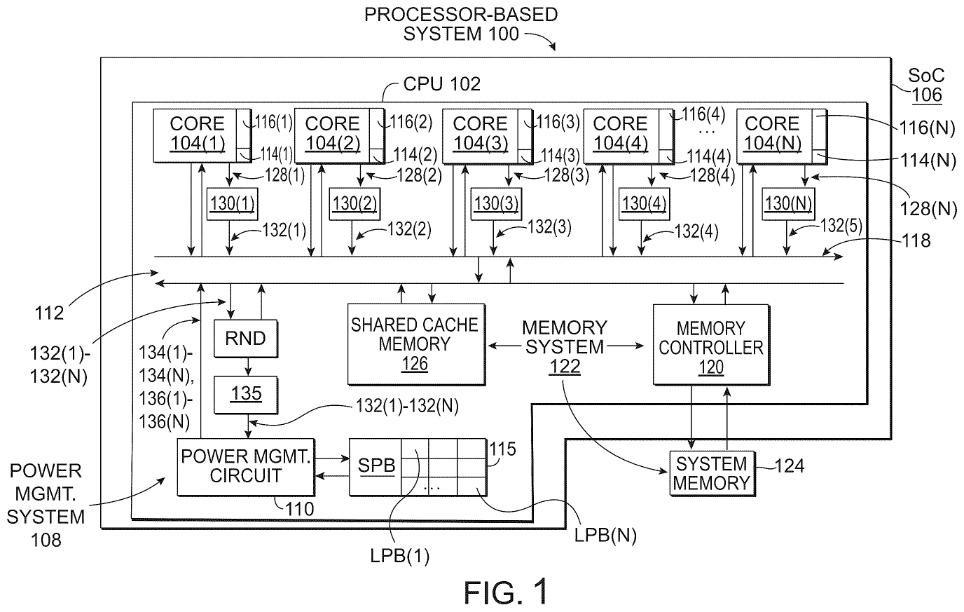

In this regard, FIG. 1 is a block diagram of an exemplary processor-based system 100 that includes a central processing unit (CPU) 102 that includes a plurality of processor cores 104(1)-104(N), also referred to herein as “cores” 104(1)-104(N). The CPU 102 can be included in a single IC chip as system-on-a-chip (SoC) 106 along with other supporting computing devices and circuitry. The processor-based system 100 includes a power management system 108 that is configured to manage power consumption of circuits in the processor-based system 100 including the cores 104(1)-104(N). The power management system 108 in this example includes a power management circuit 110 that may be a processor or other control circuitry and that may be provided as part of the CPU 102 as shown in FIG. 1 or communicatively coupled to the CPU 102. As discussed in more detail below, the power management circuit 110 is configured to determine local power budgets for the cores 104(1)-104(N) as a portion of an overall system power budget for the processor-based system 100 that is based on achieving a desired performance and/or reliability in the processor-based system 100. The local power budgets can be based on a performance state and/or priority requested by the cores 104(1)-104(N) to the power management circuit 110 through communications over an internal communication network 112 (e.g. a mesh network). The power management circuit 110 determines a performance state limit (e.g., operating voltage limit and/or operating frequency limit) and current consumption limit for each of the cores 104(1)-104(N) based on the local power budget allocated to each of the cores 104(1)-104(N). In this manner, these performance state and current consumption limits can be enforced in the cores 104(1)-104(N) to manage their power consumption according to their allocated local power budgets as part of the overall power consumption of the processor-based system 100.

With continuing reference to FIG. 1, to effectuate the determined performance and current consumption for the cores 104(1)-104(N), the power management circuit 110 is configured communicate the determined performance state limit and current consumption limit for each of the cores 104(1)-104(N) over the internal communication network 112 to be written into a performance limit register 114(1)-114(N) associated with an assigned respective core 104(1)-104(N). The performance limit registers 114(1)-114(N) are circuits that are configured to store a data word(s) and are each configured to store an encoded data word that contains a performance state limit and current consumption limit. The power management system 108 also includes performance control circuits 116(1)-116(N) that are each associated with a respective assigned core 104(1)-104(N). The performance control circuits 116(1)-116(N) may be included within the respective cores 104(1)-104(N) or outside of the cores 104(1)-104(N) within the SoC 106 in this example. The performance control circuits 116(1)-116(N) are each configured to manage the performance state of its respective assigned core 104(1)-104(N) based on the performance state limit and current consumption limit written into the respective performance limit register 114(1)-114(N) associated with its assigned core 104(1)-104(N). The performance control circuits 116(1)-116(N) are each configured to cause its assigned core 104(1)-104(N) to operate within a determined performance state limit and current consumption limit to manage its power consumption. If the desired performance state for a given core 104(1)-104(N) exceeds its performance state limit from its associated performance limit register 114(1)-114(N), the performance control circuit 116(1)-116(N) enforces the performance state limit as its assigned core's 104(1)-104(N) performance state. If the current consumption by a given core 104(1)-104(N) exceeds its current consumption limit from its associated performance limit register 114(1)-114(N), the performance control circuit 116(1)-116(N) lowers the performance state of its assigned core 104(1)-104(N) to reduce current consumption within the current consumption limit.

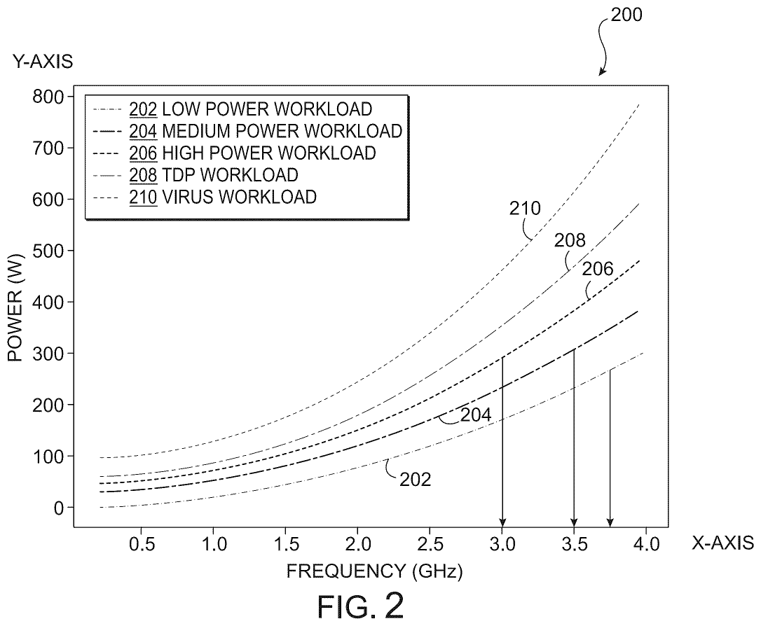

In this manner, the power consumption of the cores 104(1)-104(N) are managed by the power management system 108 according to an allocated local power budget as part of a system power budget for the entire the processor-based system 100. The power consumption of the cores 104(1)-104(N) is managed by controlling the performance and current consumption of the cores 104(1)-104(N) according to respective performance state limits and current consumption limits determined for the cores 104(1)-104(N) based on the determined respective allocated local power budgets LPB(1)-LPB(N) for the cores 104(1)-104(N) from a system power budget SPB for the CPU 102 and/or processor-based system 100. The power management circuit 110 is configured to store the system power budget SPB and the local power budgets LPB(1)-LPB(N) in a memory 115, which could be a local memory or a system memory 124 if desired. If the desired performance state of core 104(1)-104(N) for its operation exceeds the determined performance state limit for that core 104(1)-104(N), the respective performance control circuit 116(1)-116(N) limits the performance state of such assigned core 104(1)-104(N) to the performance state limit. Because the performance state of a core 104(1)-104(N) does not accurately control current consumption by the core 104(1)-104(N) due to variation in workloads, if the current consumption of the cores 104(1)-104(N) exceeds their respective current consumption limits for that core 104(1)-104(N), the respective performance control circuits 116(1)-116(N) are also configured to further limit the performance state of its assigned core 104(1)-104(N) to more accurately manage power consumption by the cores 104(1)-104(N). For example, as shown in the exemplary workload power graph 200 in FIG. 2, different workloads 202-210 performed on the same CPU or core can consume different amounts of power (W) (Y-axis) for the same operating voltage and frequency (GHz) (X-axis).

With reference back to FIG. 1, as discussed in more detail below, the performance control circuits 116(1)-116(N) may also be configured to locally throttle current consumption of their respective assigned cores 104(1)-104(N) in response to their respective current consumptions exceeding their respective current consumption limits. The performance control circuits 116(1)-116(N) can be configured to locally throttle current consumption of their respective assigned cores 104(1)-104(N) by further limiting their respective performance states. This is so that current consumption can also be throttled in a given core 104(1)-104(N) in response to detecting its current consumption limit being exceeded, while the new, lower performance state to reduce current consumption is effectuated in the core 104(1)-104(N). In this manner, the performance control circuits 116(1)-116(N) are not only configured to control performance states of their respective assigned cores 104(1)-104(N) to optimize performance level based on a given local power budget LPB(1)-LPB(N), but the performance control circuits 116(1)-116(N) are also configured to control power consumption in the their respective assigned cores 104(1)-104(N) based on their actual measured current consumption through limiting their respective performance states.

The power management circuit 110 may be configured to continually determine updated performance state and current consumption limits of the cores 104(1)-104(N) to be written into their associated performance limit registers 114(1)-114(N) on an ongoing basis. This is because the power consumption of circuits in the processor-based system 100 as a function of the overall system power budget SPB continues to change over time. For example, there may be times where power consumption in the processor-based system 100 is lower where more power budget is available to be allocated to a particular core 104(1)-104(N) to satisfy its requested performance state and/or priority. There may be other times where power consumption in the processor-based system 100 is higher, where less power budget may be available to be allocated to a particular core 104(1)-104(N) to satisfy its requested performance state and/or priority. Thus, by the power management circuit 110 continually determining allocated local power budgets LPB(1)-LPB(N) for the cores 104(1)-104(N) to then update performance state and current consumption limits of the cores 104(1)-104(N), performance in the processor-based system 100 can continue to be optimized while mainlining power consumption within the overall system power budget SPB.

Further, providing the performance limit registers 114(1)-114(N) that support a combined performance state limit and current consumption limit for the cores 104(1)-104(N) can avoid latency between the power management circuit 110 providing an updated performance state limit and an updated current consumption limit for a given core 104(1)-104(N). This is because the performance limit registers 114(1)-114(N) support storage of both with a single write operation that can be initiated by the power management circuit 110 for each performance limit register 114(1)-114(N). If multiple separate registers had to be written through multiple write operations to provide a performance state limit and current consumption limit for a given core 104(1)-104(N), the core 104(1)-104(N) may not be as effective in controlling power consumption as required by the power management system 108. For example, for a given core 104(1)-104(N), if two separate performance state and current consumption limit registers were provided, the resulting added latency between first writing an updated, lower performance state to the performance state register followed by separately writing a subsequent updated, decreased current consumption limit, could cause a core 104(1)-104(N) to initially operate at the new, updated lower performance state before the current consumption limit could be reduced to the new, decreased current consumption limit. This would risk the core 104(1)-104(N) not throttling current consumption as desired according to the new lower performance state, thus causing the core 104(1)-104(N) to possibly exceed its power budget set by the power management circuit 110. Also, as another example, if two separate performance state and current consumption limit registers were provided, the resulting added latency between first writing an updated, higher performance state to the performance state register followed by a subsequent updated, increased current consumption limit, could cause a core 104(1)-104(N) to initially operate at the higher performance state before the current consumption limit could be increased to the new, increased current consumption limit. This could cause current consumption in a core 104(1)-104(N) to be unnecessarily throttled and thus possibly reduce its performance needlessly even when its allocated power budget would allow for higher current consumption.

Additional exemplary features of the processor-based system 100 in FIG. 1 will now be discussed. The cores 104(1)-104(N) are each configured to provide requests 118 (e.g., memory access requests) to be serviced by other peripheral computing devices that are part of the processor-based system 100. For example, these requests 118 could be memory access requests that are communicated through the internal communication network 112 to a memory controller 120 that is part of a memory system 122 of the processor-based system 100, wherein the memory controller 120 services such memory access requests 118 through a system memory 124 (e.g., a dynamic random access memory (DRAM)) as part of the memory system 122. The requests 118 can also include a requested performance state from a core 104(1)-104(N) to the power management circuit 110 of the power management system 108, as discussed above. The memory system 122 may also include cache memory that is private to a respective core 104(1)-104(N) and/or shared cache memory 126 that is accessed through the internal communication network 112 and which is accessed before a resulting cache miss will result in a memory access request 118 being communicated to the memory controller 120.

In this example, the cores 104(1)-104(N) are each configured to communicate telemetry data 128(1)-128(N) to a respective telemetry producer circuit 130(1)-130(N) assigned to a respective core 104(1)-104(N). The telemetry producer circuits 130(1)-130(N) are each configured to create respective telemetry data packets 132(1)-132(N) with the respective telemetry data 128(1)-128(N) to be communicated over the internal communication network 112 to its intended destination. In this example, the telemetry data packets 132(1)-132(N) are communicated to request node RND that is in turn configured to forward the such telemetry data packets 132(1)-132(N) to a telemetry consumer circuit 135. The telemetry data 128(1)-128(N) in the telemetry data packets 132(1)-132(N) can then be provided to the power management circuit 110. In this example, the cores 104(1)-104(N) are each configured to communicate messaging telemetry data that includes a request performance state as messaging telemetry data packets 132(1)-132(N) be communicated to the power management circuit 110. The power management circuit 110 is configured to use the requested performance state from the cores 104(1)-104(N) to determine an allocated local power budget LPB(1)-LPB(N) for the cores 104(1)-104(N), to then determine the performance state and current consumption limits for the respective cores 104(1)-104(N). The power management circuit 110 is then configured to communicate the determined performance state limits and current consumption limits for the cores 104(1)-104(N) as respective performance state limits 134(1)-134(N) and current consumption limits 136(1)-136(N) over the internal communication network 112, to be written to the respective performance limit registers 114(1)-114(N). As discussed in more detail below, the processor-based system 100 is also configured to support the communication of other telemetry data over the internal communication network 112.

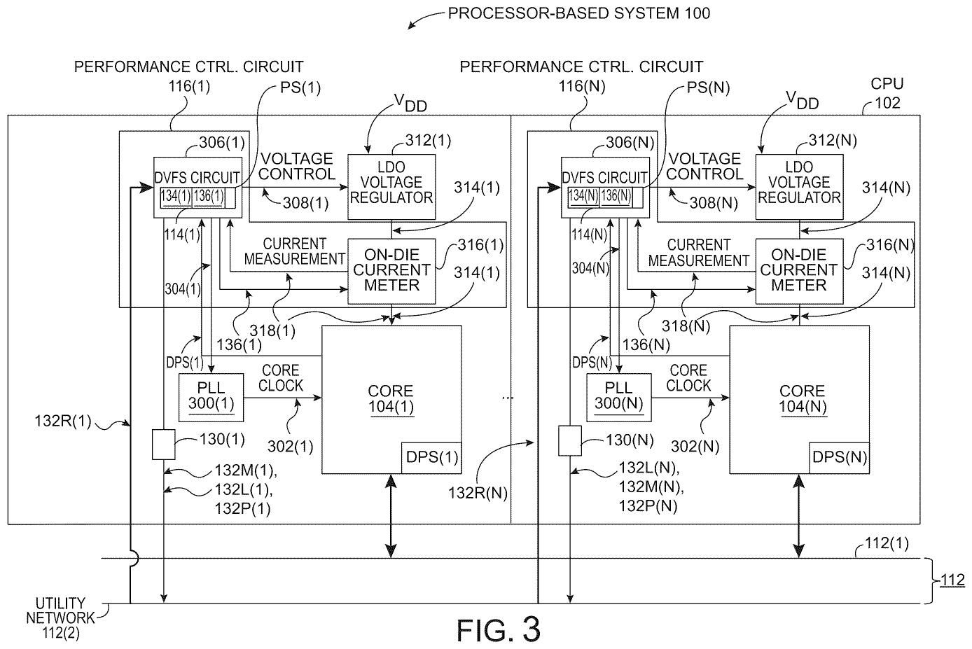

FIG. 3 is a block diagram illustrating more exemplary detail of the cores 104(1)-104(N) in the processor-based system 100 in FIG. 1. FIG. 3 represents an example of exemplary components that can be associated with the cores 104(1)-104(N) involved in providing power management for the cores 104(1)-104(N), and enforcing performance state and current consumption limits according to the performance state limits 134(1)-134(N) and current consumption limits 136(1)-136(N) determined by the power management circuit 110 in FIG. 1 described above.

In this regard, as shown in FIG. 3, the CPU 102 includes a respective local clock generation circuit 300(1)-300(N) associated with each respective assigned core 104(1)-104(N). For example, the local clock generation circuits 300(1)-300(N) can be phase-locked loop (PLL) circuits. The local clock generation circuits 300(1)-300(N) supply a respective core clock signal 302(1)-302(N) to the respective cores 104(1)-104(N) to clock operation of the cores 104(1)-104(N) at a frequency according to a desired performance state DPS(1)-DPS(N) of the respective core 104(1)-104(N). The frequency of the core clock signals 302(1)-302(N) is controlled according to respective frequency control settings 304(1)-304(N) provided by the performance control circuit 116(1)-116(N), and more particularly by a dynamic voltage frequency scaling (DVFS) circuit 306(1)-306(N) assigned to a respective core 104(1)-104(N). In this example, the DVFS circuits 306(1)-306(N) are provided as part of the respective performance control circuits 116(1)-116(N). The DVFS circuits 306(1)-306(N) are also configured to generate respective voltage control settings 308(1)-308(N) to cause a respective local voltage regulator 312(1)-312(N) to supply a respective local voltage 314(1)-314(N) to the respective cores 104(1)-104(N) to power their operation according to a desired performance state DPS(1)-DPS(N) of the core 104(1)-104(N). The local voltages 314(1)-314(N) are regulated from a supply voltage V_{DD} that is provided to the CPU 102. The desired performance state DPS(1)-DPS(N) of the core 104(1)-104(N) may be determined by the core 104(1)-104(N) itself according to the workload to be performed or other criteria, but as discussed above, limited by the performance state limit written into the respective performance limit registers 114(1)-114(N) associated with a performance control circuit 116(1)-116(N) associated with each core 104(1)-104(N). The desired performance states DPS(1)-DPS(N) of the cores 104(1)-104(N) are provided to the respective performance control circuits 116(1)-116(N) to effectuate the desired performance state DPS(1)-DPS(N) and the actual performance states PS(1)-PS(N) of the cores 104(1)-104(N). The desired performance state DPS(1)-DPS(N) of the cores 104(1)-104(N) is communicated by the respective DVFS circuits 306(1)-306(N) over the internal communication network 112 to the power management circuit 110, which in turn uses the reported, desired performance states DPS(1)-DPS(N) to determine the local power budgets LPB(1)-LPB(N) allocated to the respective cores 104(1)-104(N), and in turn to determine the performance state limits 134(1)-134(N) and current consumption limits 136(1)-136(N) for the respective cores 104(1)-104(N).

With continuing reference to FIG. 3, to facilitate the power management circuit 110 (FIG. 1) providing the performance limits of the respective cores 104(1)-104(N) according to their determined local power budgets LPB(1)-LPB(N), the power management circuit 110 is configured to receive requested performance states for the cores 104(1)-104(N) in respective messaging telemetry data packets 132M(1)-132M(N). The power management circuit 110 uses the requested performance states for the cores 104(1)-104(N) along with other information to determine local power budgets LPB(1)-LPB(N), to then determine and effectuate the communication of performance limit register data packets 132R(1)-132R(N) that include a determined performance state limit 134(1)-134(N) and current consumption limit 136(1)-136(N) for the respective cores 104(1)-104(N). The performance limit register data packets 132R(1)-132R(N) may be communicated over a utility network 112(2) that can both be part of the internal communication network 112 in FIG. 1. The performance limit register data packets 132R(1)-132R(N) are generated by the power management circuit 110 (see FIG. 1) and includes respective performance state limits 134(1)-134(N) and current consumption limits 136(1)-136(N) to be written to the respective performance limit registers 114(1)-114(N) for each respective core 104(1)-104(N). In this example, the respective performance limit registers 114(1)-114(N) are included in the respective DVFS circuits 306(1)-306(N) in the respective performance control circuits 116(1)-116(N). In response to receipt of a respective performance limit register data packets 132R(1)-132R(N) used to update the respective performance limit registers 114(1)-114(N) for each respective core 104(1)-104(N), the DVFS circuits 306(1)-306(N) are configured to communicate confirmation of a respective received performance limit register data packets 132R(1)-132R(N) over the utility network 112(2) as a respective performance limit confirmation packet 132L(1)-132L(N) to the power management circuit 110.

With continuing reference to FIG. 3, the DVFS circuits 306(1)-306(N) are each configured to determine if the performance state PS(1)-PS(N) of their respective assigned core 104(1)-104(N) exceeds the respective performance state limits 134(1)-134(N) provided by the power management circuit 110 as written into the performance limit registers 114(1)-114(N). If so, as discussed above, the DVFS circuits 306(1)-306(N) are configured to generate the appropriate voltage control settings 308(1)-308(N) and/or frequency control settings 304(1)-304(N) to limit the performance state of the respective cores 104(1)-104(N) according to the voltage and/or frequency setting for the limited performance state. The limit in performance state of a processor core 104(1)-104(N) effectuated by a respective DVFS circuit 306(1)-306(N) is communicated as a respective performance state telemetry data packet 132P(1)-132P(N) from a respective DVFS circuit 306(1)-306(N) through a respective telemetry producer circuit 130(1)-130(N) over the utility network 112(2) to the power management circuit 110 (FIG. 1).

Also, upon confirmation of any changed performance state in a core 104(1)-104(N) including due to limiting the performance state PS(1)-PS(N), the DVFS circuits 306(1)-306(N) are configured to communicate the confirmation of a changed performance state in a respective assigned core 104(1)-104(N) as a performance state telemetry data packet 132P(1)-132P(N) over the utility network 112(2). This confirmation in the performance change provided in the performance state telemetry data packets 132P(1)-132P(N) may be used by the power management circuit 110 to determine allocated local power budgets LPB(1)-LPB(N) to the respective cores 104(1)-104(N), to in turn determine/update the performance limit registers 114(1)-114(N) for the respective cores 104(1)-104(N). Again, the power management circuit 110 can also use any limiting of performance state of a core 104(1)-104(N) to re-determine the local power budgets LPB(1)-LPB(N) allocated to the respective cores 104(1)-104(N), to in turn determine/update the performance limit registers 114(1)-114(N) for the respective cores 104(1)-104(N).

With continuing reference to FIG. 3, the CPU 102 includes a respective current measurement circuit 316(1)-316(N) assigned to a respective core 104(1)-104(N). The current measurement circuits 316(1)-316(N) are located on the same die as the cores 104(1)-104(N) in this example and provided as separate circuits outside of the performance control circuits 116(1)-116(N) in this example. The current measurement circuits 316(1)-316(N) are each configured to measure the current consumption by its respective assigned core 104(1)-104(N) and provide a respective current consumption measurement 318(1)-318(N) to the respective DVFS circuits 306(1)-306(N). As discussed above, the DVFS circuits 306(1)-306(N) are each configured to determine if the current consumption according to the current consumption measurement 318(1)-318(N) for its respective assigned core 104(1)-104(N) exceeds the respective current consumption limits 136(1)-136(N) written into its performance limit register 114(1)-114(N). If so, as discussed above, the DVFS circuits 306(1)-306(N) are configured to generate the appropriate voltage control settings 308(1)-308(N) and/or frequency control settings 304(1)-304(N) to limit the performance state of the respective cores 104(1)-104(N) according to the voltage and/or frequency setting to attempt to reduce current consumption to at or below the current consumption limit 136(1)-136(N). Upon confirmation of a changed performance state in a core 104(1)-104(N) due to limiting the performance state PS(1)-PS(N) due to exceeded current consumption, the core 104(1)-104(N) is configured to communicate the confirmation of a changed performance state in a core 104(1)-104(N) over the utility network 112(2). This confirmation may be used by the power management circuit 110 to determine allocated local power budgets LPB(1)-LPB(N) to the cores 104(1)-104(N). Again, the power management circuit 110 can use the limited performance state to re-determine the local power budgets LPB(1)-LPB(N) allocated to the respective cores 104(1)-104(N).

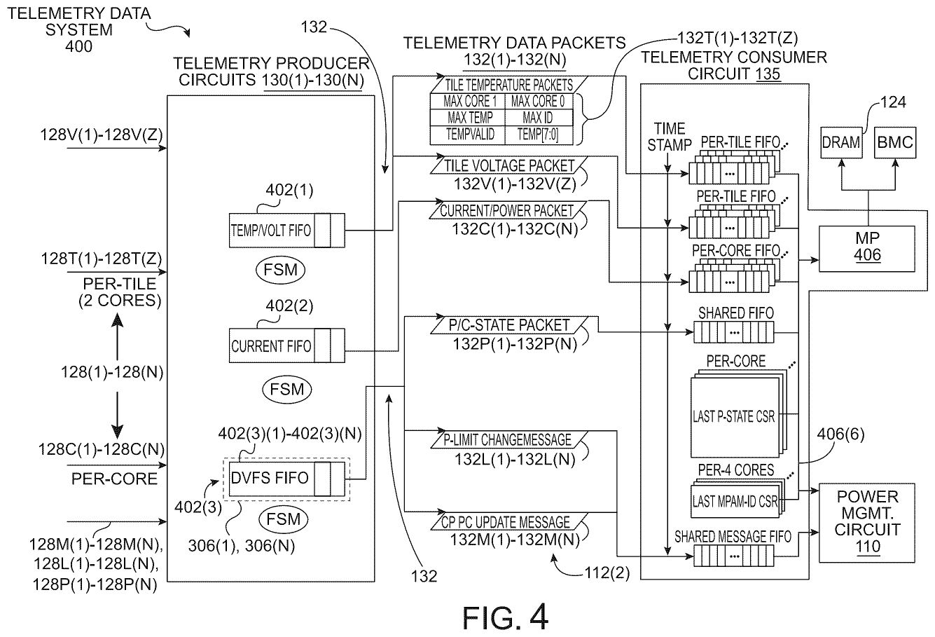

FIG. 4 is a block diagram illustrating more exemplary detail of a telemetry data system 400 that can be provided in the processor-based system 100 in FIG. 1 to facilitate communication of data to and from the power management circuit 110. As shown in FIG. 4, the telemetry producer circuits 130(1)-130(N) are each configured to transmit received respective telemetry data 128(1)-128(N) having telemetry information regarding the respective cores 104(1)-104(N). In this example, certain telemetry data 128C(1)-128C(N), such as current consumption data, may be provided by each core 104(1)-104(N) on a per core basis. Other telemetry data 128T(1)-128T(Z), such as temperature and voltage data, may be provided for a core 104(1)-104(N) or tile of multiple cores 104(1)-104(N). The telemetry producer circuits 130(1)-130(N) each include the shown buffer circuits 402(1)-402(3) that are configured to store received telemetry data 128(1)-128(N) as it is received to prepare to generate telemetry data packets 132(1)-132(N) with such telemetry data 128(1)-128(N) to be communicated over the utility network 1122) to the telemetry consumer circuit 135 and to the power management circuit 110.

In this example, each telemetry producer circuits 130(1)-130(N) contains a first buffer circuit 402(1) as a FIFO circuit that is configured to store the received temperature telemetry data 128T(1)-128T(Z) on a per core 104(1)-104(N) tile basis. The first buffer circuit 402(1) is also configured to store voltage data from received voltage telemetry data 128V(1)-128V(Z) on a per core 104(1)-104(N) tile basis. The telemetry producer circuits 130(1)-130(N) also each include a second buffer circuit 402(2) as a FIFO circuit that is configured to store current consumption data from received current consumption telemetry data 128C(1)-128C(N) on a per core 104(1)-104(N) basis. The telemetry producer circuits 130(1)-130(N) also each include a third buffer circuit 402(3) as a FIFO circuit that is configured to store performance telemetry data 128P(1)-128P(N) on a per core 104(1)-104(N) basis relating to a change in performance state of the core 104(1)-104(N) that can be used to determine the actual performance state of each core 104(1)-104(N). The third buffer circuit 402(3) is also configured to store messaging telemetry data 128M(1)-128M(N) that indicates a desired performance state for a given core 104(1)-104(N) on a per core 104(1)-104(N) basis. The third buffer circuit 402(3) is also configured to store the performance limit confirmation messages 128L(1)-128L(N) that indicate a confirmation and enforcement (i.e., a new performance limit received and performance state lowered to new received performance limit) of a received performance state limit 134(1)-134(N) and current consumption limit 136(1)-136(N) on a per core 104(1)-104(N) basis.

With continuing reference to FIG. 4, the telemetry producer circuits 130(1)-130(N) are configured to generate respective temperature telemetry data packets 132T(1)-132T(Z) with temperature telemetry data for each core 104(1)-104(N) tile, which may include maximum temperature of each core 104(1)-104(N) in a given core 104(1)-104(N) tile, and max temperature of the entire core 104(1)-104(N) tile. The telemetry producer circuit 130(1)-130(N) are also configured to generate voltage telemetry data packets 132V(1)-132V(Z) with voltage telemetry data for each core 104(1)-104(N) tile. The telemetry producer circuits 130(1)-130(N) are also configured to generate respective current consumption telemetry data packets 132C(1)-132C(N) with current consumption telemetry data for each core 104(1)-104(N). The telemetry producer circuits 130(1)-130(N) are also configured to generate other respective telemetry data packets 132(1)-132(N) that are not synchronous, meaning their respective telemetry data is not generated in response to a synchronous, sampling time window but generated asynchronously. These asynchronously generated telemetry data packets 132(1)-132(N) include generated performance state telemetry data packets 132P(1)-132P(N) with performance states of the cores 104(1)-104(N), performance limit confirmation packets 132L(1)-132L(N) with confirmation and enforcement of a respective received performance state limit 134(1)-134(N) and current consumption limit 136(1)-136(N), and messaging telemetry data packets 132M(1)-132M(N) with requested performance states generated by the cores 104(1)-104(N).

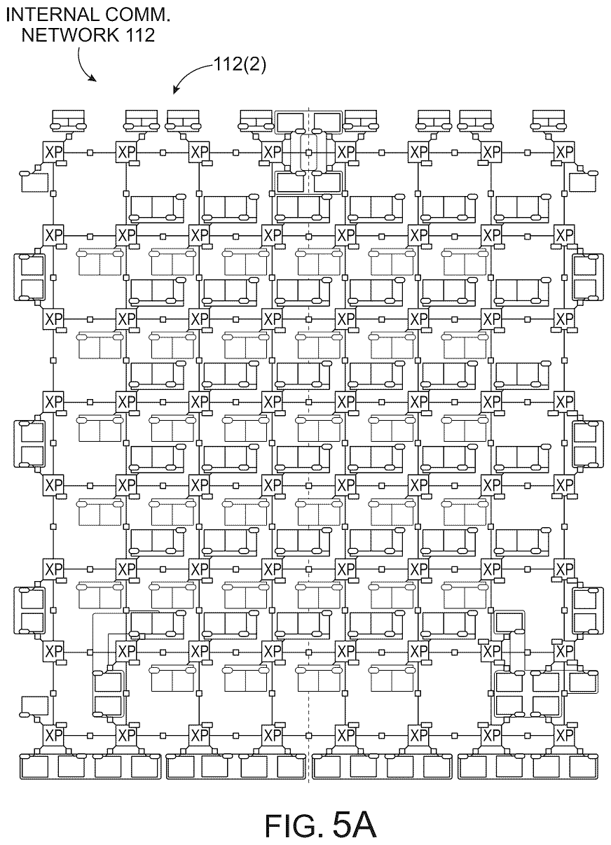

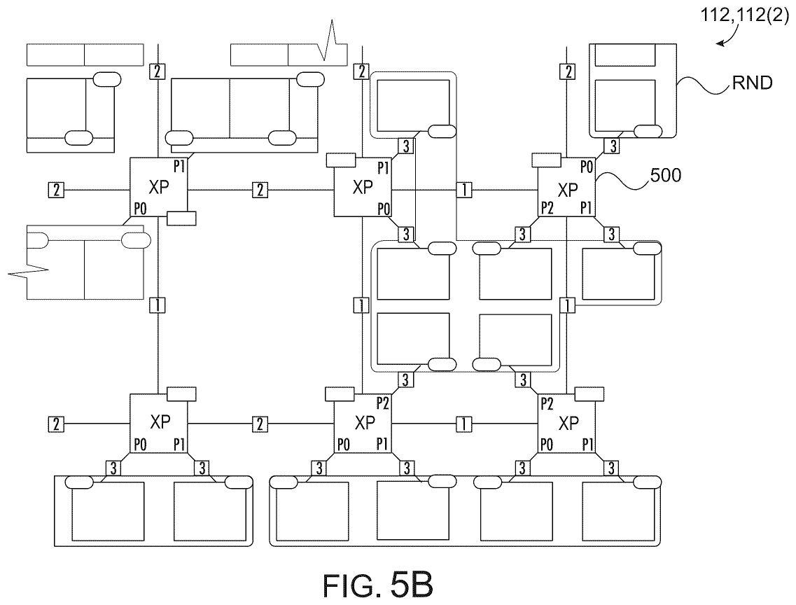

With continuing reference to FIG. 4, the telemetry producer circuits 130(1)-130(N) are configured to transmit the respective telemetry data packets 132(1)-132(N) onto the utility network 112(2) to be received by the telemetry consumer circuit 135. For example, FIG. 5A is a block diagram illustrating more exemplary detail of the utility network 1122) as part of the internal communication network 112, which is shown as a mesh network with multiple network nodes XP that can manage propagating data through multiple data paths. FIG. 5B is a diagram illustrating exemplary detail of the utility network 1122) as part of the internal communication network 112 in FIG. 5A, wherein a specified network node XP 500 is configured to be interfaced to the telemetry consumer circuit 135 to forward telemetry data packets 132(1)-132(N) to the telemetry consumer circuit 135 in the telemetry data system 400 in FIG. 4.

With continuing reference to FIG. 4, the telemetry producer circuits 130(1)-130(N) are configured to transmit the respective telemetry data packets 132(1)-132(N) onto the utility network 112(2) to be received by the telemetry consumer circuit 135. The telemetry consumer circuit 135 is configured to provide the voltage telemetry data 128V(1)-128V(N), current consumption telemetry data 128C(1)-128(N), and temperature telemetry data 128T(1)-128T(N) from the received respective telemetry data packets 132V(1)-132V(N), 132C(1)-132C(N), 132T(1)-132T(N) to a management processor 406. The telemetry consumer circuit 135 is configured to provide the performance limit confirmation messages 128L(1)-128L(N) and messaging telemetry data 128M(1)-128M(N) from the received respective performance limit confirmation packets 132L(1)-132L(N) and messaging telemetry data packets 132M(1)-132M(N) to the power management circuit 110.

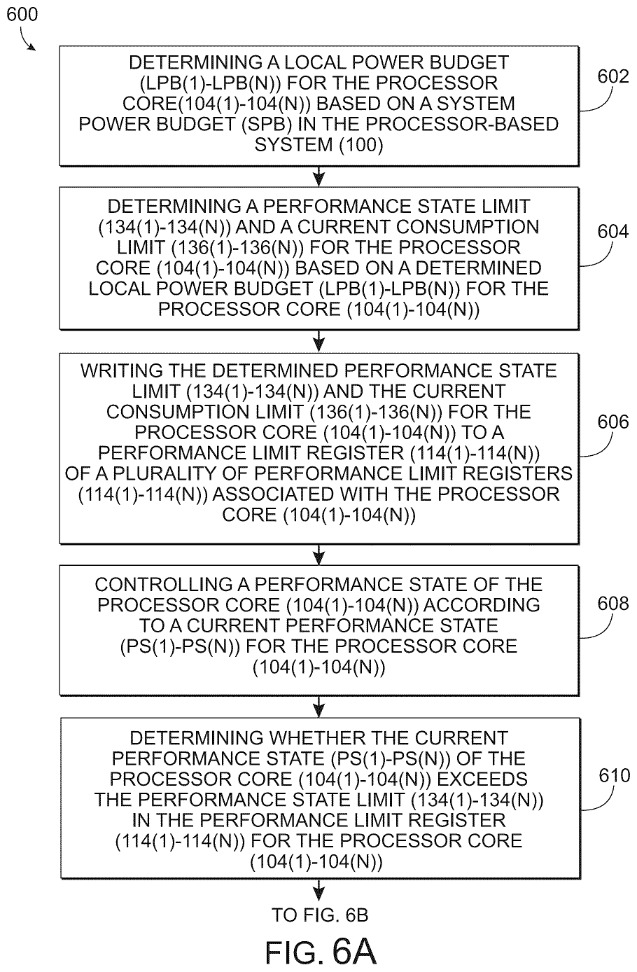

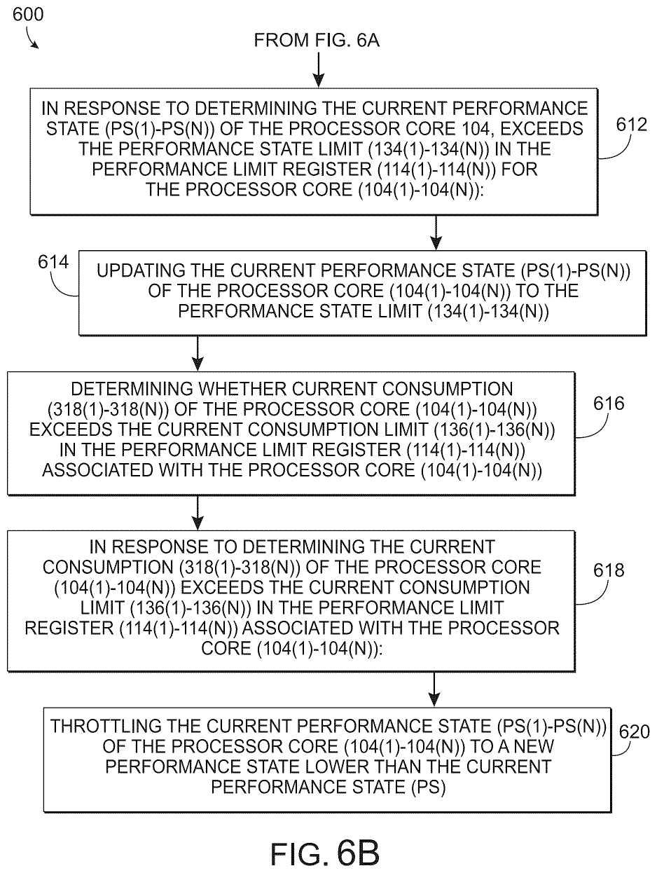

FIGS. 6A and 6B is a flowchart illustrating an exemplary core performance management process 600 of a power management circuit in a processor-based system, including the power management circuit 110 in FIGS. 1 and 4 in the processor-based system 100 in FIGS. 1, 3 and 4, determining performance state limit and current consumption limit for each core based on a determined power budget for each core, and writing the determined performance state limit and current consumption limit for each core into its respective performance limit register. The exemplary core performance management process 600 in FIGS. 6A and 6B is described with reference to the processor-based system in FIGS. 1 and 3-4 as a non-limiting example.

In this regard, as illustrated in FIG. 6A, a first step in the core performance management process 600 can be the power management circuit 110 determining a local power budget LPB(1)-LPB(N) for the processor core 104, 104(1)-104(N) based on a system power budget SPB in the processor-based system 100 (block 602 in FIG. 6A). A next step in the core performance management process 600 can be the power management circuit 110 determining a performance state limit 134(1)-134(N) and a current consumption limit 136(1)-136(N) for the processor core 104(1)-104(N) based on a determined local power budget LPB(1)-LPB(N) for the processor core 104(1)-104(N) (block 604 in FIG. 6A). A next step in the core performance management process 600 can be the power management circuit 110 writing the determined performance state limit 134(1)-134(N) and the current consumption limit 136(1)-136(N) for the processor core 104(1)-104(N) to a performance limit register 114(1)-114(N) of a plurality of performance limit registers 114(1)-114(N) associated with the processor core 104(1)-104(N) (block 606 in FIG. 6A).

With continued reference to FIG. 6A, a next step in the core performance management process 600 can be the performance control circuits 116(1)-116(N), for each core 104(1)-104(N), controlling a performance state of the processor core 104(1)-104(N) according to a current performance state PS(1)-PS(N) for the processor core 104(1)-104(N) (block 608 in FIG. 6A). A next step in the core performance management process 600 can be the performance control circuits 116(1)-116(N), for each core 104(1)-104(N), determining whether the current performance state PS(1)-PS(N) of the processor core 104(1)-104(N) exceeds the performance state limit 134(1)-134(N) in the performance limit register 114(1)-114(N) for the processor core 104(1)-104(N) (block 610 in FIG. 6A). Then, as shown in FIG. 6B, a next step in the core performance management process 600 can be the performance control circuits 116(1)-116(N), for each core 104(1)-104(N), in response to determining the current performance state PS(1)-PS(N) of the processor core 104(1)-104(N), exceeds the performance state limit 134(1)-134(N) in the performance limit register 114(1)-114(N) associated with the processor core 104(1)-104(N) (block 612 in FIG. 6B), updating the current performance state PS(1)-PS(N) of the processor core 104(1)-104(N) to the performance state limit 134(1)-134(N) (block 614 in FIG. 6B).

Then, as shown in FIG. 6B, a next step in the core performance management process 600 can be the performance control circuits 116(1)-116(N), for each core 104(1)-104(N), determining whether current consumption 318(1)-318(N) of the processor core 104(1)-104(N) exceeds the current consumption limit 136(1)-136(N) in the performance limit register 114(1)-114(N) associated with the processor core 104(1)-104(N) (block 616 in FIG. 6B). Then, as shown in FIG. 6B, a next step in the core performance management process 600 can be the performance control circuits 116(1)-116(N), for each core 104(1)-104(N), in response to determining the current consumption 318(1)-318(N) of the processor core 104(1)-104(N) exceeds the current consumption limit 136(1)-136(N) in the performance limit register 114(1)-114(N) associated with the processor core 104(1)-104(N) (block 618 in FIG. 6B), throttling the current performance state (PS(1)-PS(N)) of the processor core (104(1)-104(N)) to a new performance state lower than the current performance state (PS) (block 620 in FIG. 6B).

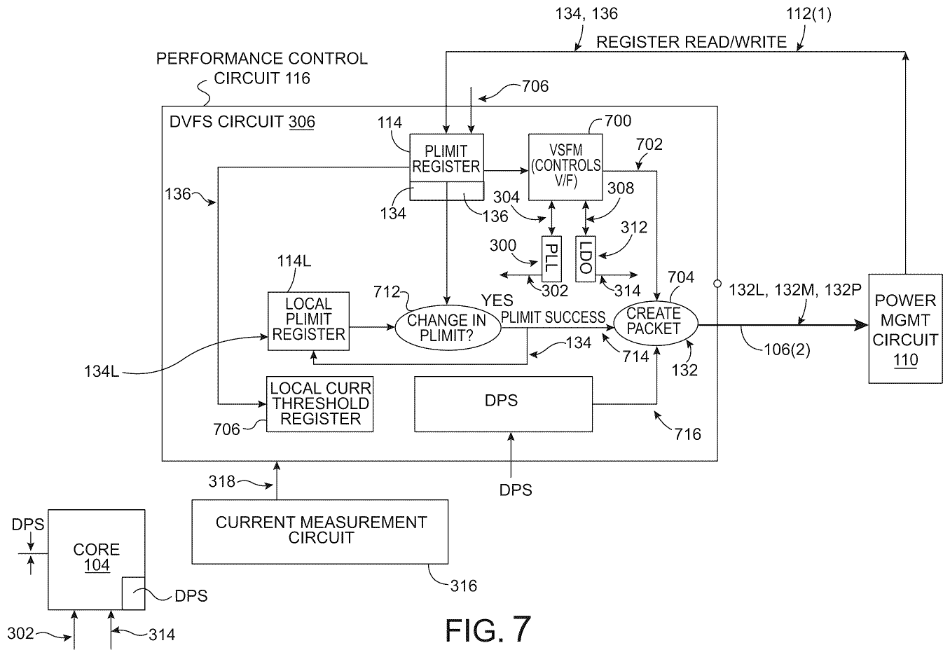

FIG. 7 is a block diagram illustrating other exemplary detail of the performance control circuit 116 in the processor-based system 100 in FIGS. 1 and 3 that is configured to manage performance of an associated respective core 104(1)-104(N) according to a performance state limit 134 and current consumption limit 136 written to a performance limit register 114 by the power management circuit 110. The exemplary performance control circuit 116 in FIG. 7 can be any of the performance control circuits 116(1)-116(N) in the processor-based system 100 in FIGS. 1 and 3. In this example, the performance control circuit 116 is provided as the DVFS circuit 306 that can be like the DVFS circuits 306(1)-306(N) in FIG. 3. Common elements and signals between the DVFS circuit 306 in FIG. 7 and the DVFS circuits 306(1)-306(N) in FIG. 3 are shown with common element numbers, except that in FIG. 7, such element numbers are not noted with ‘(1)-(N)’ since such elements are shown with regard to a single DVFS circuit 306.

In this regard, in the exemplary performance control circuit 116 in FIG. 7, the DVFS circuit 306 includes a performance limit register 114 like the performance limit registers 114(1)-114(N). The performance limit register 114 is configured to be associated with a specific assigned core 104 like the cores 104(1)-104(N) in FIGS. 1 and 3. The performance control circuit 116 is configured to be written with a performance state limit 134 and a current consumption limit 136 that was determined and communicated over the utility network 112(1) by the power management circuit 110. The DVFS circuit 306 includes circuits that are configured to work together to perform a state machine to manage performance of an associated respective core 104(1)-104(N) according to the performance state limit 134 and the current consumption limit 136.

With continuing reference to FIG. 7, the DVFS circuit 306 is configured to provide the performance state limit 134 and a current consumption limit 136 to a voltage frequency state machine (VFSM) 700. The VFSM 700 is configured to issue a frequency control setting 304 and voltage control setting 308 to the respective local clock generation circuit 300 and local voltage regulator 312 based on the performance state limit 134. If the performance state of the core 104 associated with the DVFS circuit 306 exceeds the performance state limit 134, the VFSM 700 is configured to limit the voltage and/or frequency supplied to the associated core 104 through the respective frequency control setting 304 and voltage control setting 308 to limit the performance state of the associated core 104. The VFSM 700 is also configured to generate a performance state change signal 702 to report the change in performance state for the associated core 104 to a packet generator circuit 704. The packet generator circuit 704 is configured to generate a performance limit confirmation packet 132L to report the confirmed change in performance state for the associated core 104 to the power management circuit 110. As previously discussed with regard to FIGS. 1 and 3, the power management circuit 110 is configured use the confirmation of the performance state change for the core 104 to adjust local power budgets and associated performance state limits for cores including the performance state limit 134 and current consumption limit 136 for the core 104, since the performance state PS affects power consumption by the core 104.

In this example, the current measurement circuit 316 determines the current consumption by its associated core 104. The current measurement circuit 316 is configured to provide the current consumption measurement 318 of the current consumption of its associated core 104 to the DVFS circuit 306 assigned to the core 104. The DVFS circuit 306 uses the current measurement circuit 316 to determine if the current consumption of the core 104 exceeds the current consumption limit 136. If so, as discussed above, the DVFS circuit 306 is configured to limit the performance state of the associated core 104. As also discussed above, this in turn causes the VFSM 700 to generate the frequency control setting 304 and/or voltage control setting 308 to lower the performance state PS of the core 104 to reduce current consumption.

Also, this example includes a performance limit change comparator 712 that is configured to determine if there has been a change in the performance state limit 134 written into the performance limit register 114 that could cause a change in the performance state of the associated core 104. The performance limit change comparator 712 is configured to compare a local performance state limit 134L that was written the local performance state limit register 114L to the newly written performance state limit 134 into the performance limit register 114. If a change has occurred, the new newly written performance state limit 134 is written into the local performance state limit register 114L. The performance limit change comparator 712 is configured to generate a performance change signal 714 (also shown in FIG. 7 as PLIMIT SUCCESS) to cause the packet generator circuit 704 to generate a performance state telemetry data packet 132P to be communicated to the power management circuit 110. As previously discussed, the power management circuit 110 uses the reporting of an effectuated performance state in the core 104 to determine power budgets LPB(1)-LPB(N) and associated performance state limits for cores including the performance state limit 134 and current consumption limit 136 for the core 104.

Also with regard to FIG. 7, if there is a change in the desired performance state DPS of the core 104, the change in the desired performance state DPS is communicated to the associated DVFS circuit 306. The DVFS circuit 306 is configured to generate a desired performance state signal 716 to the packet generator circuit 704 to in turn generate a desired performance state messaging telemetry data packet 132M with the desired performance state DPS of the associated core 104. The messaging telemetry data packet 132M is communicated to the power management circuit 110. As previously discussed, the power management circuit 110 uses the desired performance state in the messaging telemetry data packet 132M to determine if a local power budget for the core 104 that included a change in the desired performance state DPS should be adjusted in turn to generate an adjusted performance state limit 134 and/or current consumption limit 136 for the core 104.

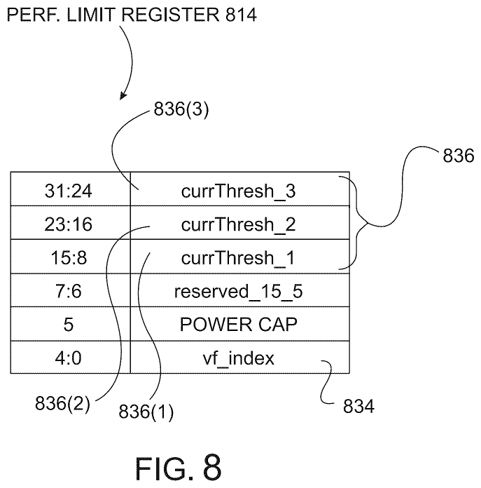

FIG. 8 is a block diagram illustrating an exemplary performance limit register 814 that can be the performance limit registers 114, 114(1)-114(N) in FIGS. 3 and 7. As shown in FIG. 8, the performance limit register 814 is a performance state limit 834 that can be the performance state limits 134, 134(1)-134(N) in FIGS. 3 and 7. In this example, performance state limit 834 is provided as a voltage frequency index vf_index which is five (5) bits wide (4:0) that encodes an operating voltage and operating frequency for an associated performance state. The voltage frequency index vf_index configured to be used by the by the DVFS circuits 306 in FIG. 7 and the DVFS circuits 306(1)-306(N) in FIG. 3 to control the local voltage 314, 314(1)-314(N) and frequency of the core clock signal 302, 302(1)-302(N) supplied to an associated core 104. The performance states that are possible to be implemented can be provided as voltage/frequency pairs.

With continuing reference to FIG. 8, in this example, the performance limit register 814 also includes a current consumption limit 836 that can be the current consumption limits 136, 136(1)-136(N) in FIGS. 3 and 7. In this example, three (3) current consumption limits 836(1)-836(3) that are each eight (8) bits wide as respective bits 15:8, 23:16, and 31:24. The current consumption limits 836(1)-836(3) are used to determine how an associated core 104 may be exceeding current consumption limits. For example, providing multiple current consumption limits 836(1)-836(3) allows different actions to be taken depending on the current consumption of an associated core 104. For example, the three (3) current consumption limits 836(1)-836(3) may be two (2) Amps (A), 5A, and 10A, respectively.

In this example, if current consumption by a given core 104(1)-104(N) is determined by its assigned performance control circuit 116(1)-116(N) to exceed the highest current consumption limit 836(3), the performance control circuit 116(1)-116(N) associated with the core 104(1)-104(N) could be configured to reduce the performance state of the core 104(1)-104(N) by multiple performance levels (i.e., multiple voltage and/or frequency steps) to reduce current consumption in the core 104(1)-104(N). In another example, if current consumption by a given core 104(1)-104(N) is determined by its assigned performance control circuit 116(1)-116(N) to not exceed a lowest current consumption limit 836(1), the performance control circuit 116(1)-116(N) associated with the core 104(1)-104(N) could be configured to maintain the current performance state of the core 104(1)-104(N) as called for in its associated respective performance limit register 114(1)-114(N). In another example, if current consumption by a given core 104(1)-104(N) is determined by its assigned performance control circuit 116(1)-116(N) to exceed an intermediate current consumption limit 836(2), but not exceed the highest current consumption limit 836(3), the performance control circuit 116(1)-116(N) associated with the core 104(1)-104(N) could be configured to lower the current performance state of the core 104(1)-104(N) by a single performance level (i.e., one voltage and/or frequency step). In yet another example, if current consumption of a given core 104(1)-104(N) that once exceeded the intermediate current consumption limit 836(2), is subsequently determined to no longer exceed the intermediate current consumption limit 836(2), the performance control circuit 116(1)-116(N) associated with the core 104(1)-104(N) could be configured to not lower the performance state of the core 104(1)-104(N) back to the performance state called for in its performance limit register 114(1)-114(N) until the current consumption of the core 104(1)-104(N) falls back below the lowest current consumption limit 836(1).

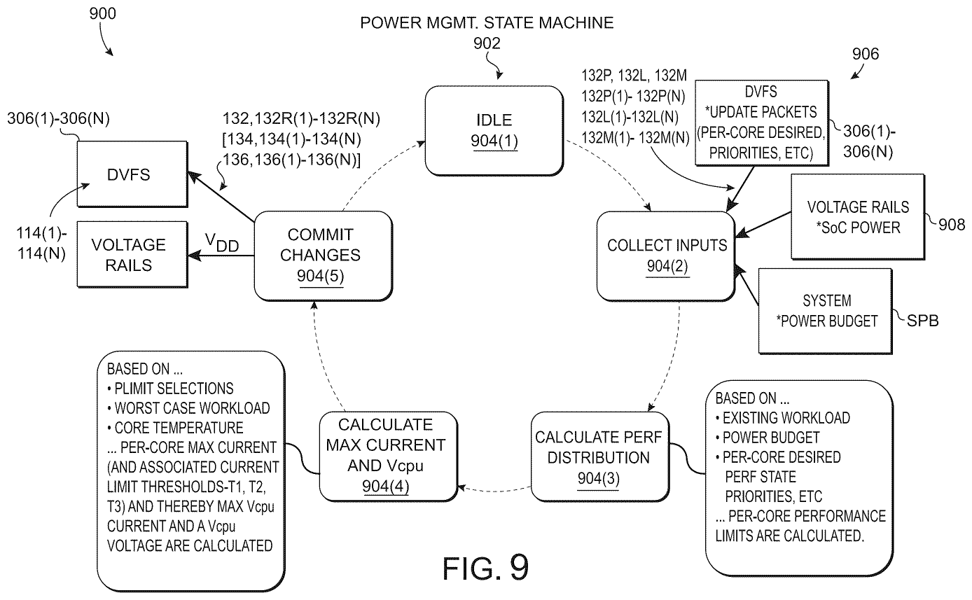

FIG. 9 is a flowchart illustrating an exemplary power management process 900 that can be performed by a power management circuit in a processor-based system 100 in FIG. 1, including the power management circuit 110 in the processor-based system 100 in FIGS. 1, 4, and 7, to determine performance state limits and current consumption limits for processor cores, including cores 104, 104(1)-104(N). In this example, for the power management circuit 110 to perform the power management process 900, the power management circuit 110 is configured to execute a power management state machine 902. The power management process 900 is discussed using the example of the processor-based system 100 and its cores 104, 104(1)-104(N) in FIGS. 1, 4, and 7.

In this regard, as shown in FIG. 9, the power management state machine 902 enters into an idle state 904(1) after a performance state change is made in a core 104, 104(1)-104(N) from a performance state commit state 904(5) (discussed below). This is to provide time for any performance state changes made to core 104, 104(1)-104(N) to settle before the power management circuit 110 collects new inputs to determine allocated local power budgets for the core 104, 104(1)-104(N). In this regard, the power management state machine 902 transitions from the idle state 904(1) to a collect input state 904(2). In the collect input state 904(2), the power management circuit 110 is configured to collect inputs 906 that will affect how local power budgets are allocated to the cores 104, 104(1)-104(N). These inputs 906 include desired performance states DPSs of the cores 104, 104(1)-104(N) from received f messaging telemetry data packets 132M, 132M(1)-132M(N), confirmed performance state changes in the cores 104, 104(1)-104(N) from received performance limit confirmation packets 132L, 132L(1)-132L(N), and performance state updates in the cores 104, 104(1)-104(N) from received performance state telemetry data packets 132P, 132P(1)-132P(N), as previously discussed. Other inputs include the system power budget SPB and voltage on voltage rails in the processor-based system 100.

With continuing reference to FIG. 9, after inputs 906 are collected in the input collect state 904(2), the power management state machine 902 transitions to the calculate performance distribution state 904(3). In this state, the power management circuit 110 determines the power budget from the system power budget SPB to be allocated to the cores 104, 104(1)-104(N) so that the total power consumed in the power management circuit 110 can be limited to the system power budget SPB. The power management circuit 110 uses knowledge of the desired performance and priorities of the cores 104, 104(1)-104(N) to determine the local power budgets LPBs for the cores 104, 104(1)-104(N) as a portion of the overall the system power budget SPB. This in turn is used to determine the performance state limits 134, 134(1)-134(N) and current consumption limits 136, 136(1)-136(N) for the cores 104, 104(1)-104(N) to be written into the respective performance limit registers 114, 114(1)-114(N).

With continuing reference to FIG. 9, after the power management circuit 110 determines the performance state limits 134, 134(1)-134(N) and current consumption limits 136, 136(1)-136(N) for the cores 104, 104(1)-104(N) in the calculate performance distribution state 904(3), the power management state machine 902 transitions to the calculate max current and voltage state 904(4). In this state, the power management circuit 110 calculates the maximum supply voltage V_{DD} to be supplied to the cores 104, 104(1)-104(N) based on the determined performance state limits 134, 134(1)-134(N) and current consumption limits 136, 136(1)-136(N), worst case workloads of the cores 104, 104(1)-104(N), the temperature in the cores 104, 104(1)-104(N). This is so the supply voltage V_{DD} will be compatible with any confirmed performance state change in the processor cores so that the supply voltage V_{DD} is compatible with the performance state in the processor cores 104, 104(1)-104(N), the power management circuit 110 may need to increase the supply voltage V_{DD} provided to the core 104, 104(1)-104(N) so that the increased performance state can be achieved. As an example, the power management circuit 110 may be configured to increase the supply voltage V_{DD} provided to the cores 104, 104(1)-104(N) before receiving confirmation of the written performance limits to the respective performance limit registers 114(1)-114(N). There is a positive correlation between supply voltage V_{DD} and operating frequency that can be achieved in a core 104, 104(1)-104(N). As another example, if a performance state is limited in a core 104, 104(1)-104(N) due to exceeding its performance state limit 134, 134(1)-134(N) or its current consumption exceeding its current consumption limit 136, 136(1)-136(N), in response to such notification, the power management circuit 110 may be configured to lower the supply voltage V_{DD} provided to the cores 104, 104(1)-104(N) to conserve power while still providing a supply voltage V_{DD} that is compatible with the limited performance state. As an example, the power management circuit 110 may be configured to only lower the supply voltage V_{DD} provided to the cores 104, 104(1)-104(N) after receiving confirmation of the written performance limits to the respective performance limit registers 114(1)-114(N) according to a received respective performance limit confirmation packets 132L(1)-132L(N). In an example, the power management circuit 110 will not alter the supply voltage V_{DD} until all expected performance limit confirmation packets 132L(1)-132L(N) are received.

With continuing reference to FIG. 9, after the power management circuit 110 calculates the maximum supply voltage V_{DD} to be supplied to the cores 104, 104(1)-104(N) in the calculate max current and voltage state 904(4), the power management state machine 902 transitions to the commit changes state 904(5). In this state, the power management circuit 110 is configured to generate the performance limit register data packets 132R(1)-132R(N) that include the determined performance state limits 134, 134(1)-134(N) and current consumption limit 136, 136(1)-136(N) for the respective cores 104, 104(1)-104(N). As previously discussed, the performance limit register data packets 132R(1)-132R(N) may be communicated on the internal communications network 112 or the utility network 112(2) that can be part of the internal communications network 112. The performance state limits 134, 134(1)-134(N) and current consumption limit 136, 136(1)-136(N) are written into the respective performance limit registers 114, 114(1)-114(N) as discussed above. The power management circuit 110 is also configured to control the supply voltage V_{DD} provided to operate the cores 104, 104(1)-104(N) based on the determined supply voltage V_{DD} in the calculate max current and voltage state 904(4) described above.

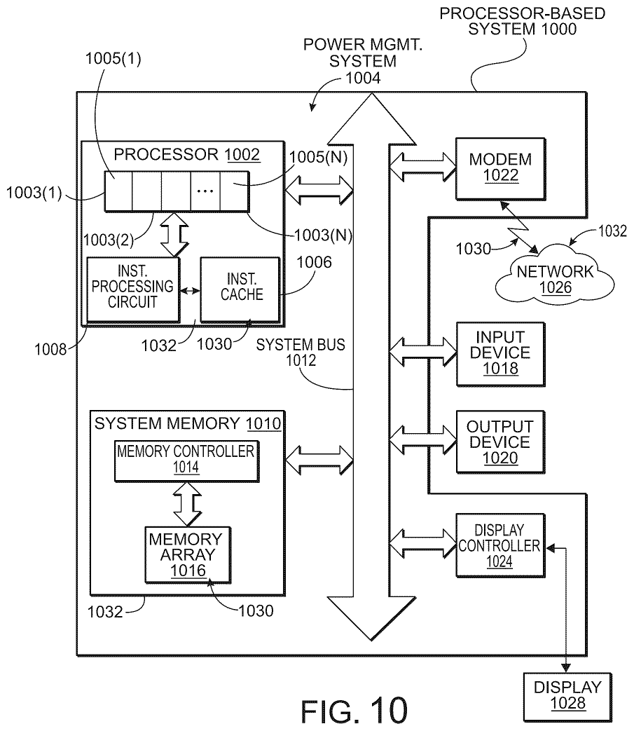

FIG. 10 is a block diagram of an exemplary processor-based system 1000 that can be the processor-based system 100 in FIGS. 1, 3-4, and 7, and wherein the processor-based system 1000 includes a processor 1002 and a plurality of processor cores (“cores”) 1003(1)-1003(N), and an exemplary power management system 1004 configured to write a determined performance state limit and determined current consumption limit to a performance limit register 1005(1)-1005(N) for each core 1003(1)-1003(N), and configured to limit the performance state of each core 1003(1)-1003(N) based on the respective performance state limit and current consumption limit set written for the assigned core 1003(1)-1003(N), including according to, but not limited to, the processes 600, 900 in FIGS. 6A-6B and 9.

The processor-based system 1000 includes the processor 1002. The processor-based system 1000 may be a circuit or circuits included in an electronic board card, such as a printed circuit board (PCB), a server, a personal computer, a desktop computer, a laptop computer, a personal digital assistant (PDA), a computing pad, a mobile device, or any other device, and may represent, for example, a server or a user's computer. In this example, the processor-based system 1000 includes the processor 1002. The processor 1002 represents one or more general-purpose processing circuits, such as a microprocessor, central processing unit, or the like. The processor 1002 is configured to execute processing logic in computer instructions for performing the operations and steps discussed herein.

The processor 1002 also includes an instruction cache 1006 for temporary, fast access memory storage of instructions and an instruction processing circuit 1008. Fetched or prefetched instructions from a memory, such as from a system memory 1010 over the system bus 1012, are stored in the instruction cache 1006. The instruction processing circuit 1008 is configured to process instructions fetched into the instruction cache 1006 and process the instructions for execution. The instruction processing circuit 1008 is configured to insert the fetched instructions into one or more instruction pipelines that are then processed to execution.

The processor 1002 and the system memory 1010 are coupled to the system bus 1012 and can intercouple peripheral devices included in the processor-based system 1000. The processor 1002 and its cores 1003(1)-1003(N) communicate with these other devices by exchanging address, control, and data information over the system bus 1012. For example, the processor 1002 can communicate performance state information related to the cores 1003(1)-1003(N). Performance limits can be received over the system bus 1012. Although not illustrated in FIG. 10, multiple system buses 1012 could be provided, wherein each system bus constitutes a different fabric. In this example, the memory controller 1014 is configured to provide memory read and/or write requests to a memory array 1016 in the system memory 1010. The memory array 1016 is comprised of an array of storage bit cells for storing data. The system memory 1010 may be a read-only memory (ROM), flash memory, dynamic random access memory (DRAM), such as synchronous DRAM (SDRAM), etc., and a static memory (e.g., flash memory, static random access memory (SRAM), etc.), as non-limiting examples.

Other devices can be connected to the system bus 1012. As illustrated in FIG. 10, these devices can include the system memory 1010, one or more input device(s) 1018, one or more output device(s) 1020, a modem 1022, and one or more display controllers 1024, as examples. The input device(s) 1018 can include any type of input device, including, but not limited to, input keys, switches, voice processors, etc. The output device(s) 1020 can include any type of output device, including, but not limited to, audio, video, other visual indicators, etc. The modem 1022 can be any device configured to allow exchange of data to and from a network 1026. The network 1026 can be any type of network, including, but not limited to, a wired or wireless network, a private or public network, a local area network (LAN), a wireless local area network (WLAN), a wide area network (WAN), a BLUETOOTH™ network, and the Internet. The modem 1022 can be configured to support any type of communications protocol desired. The processor 1002 may also be configured to access the display controller(s) 1024 over the system bus 1012 to control information sent to one or more displays 1028. The display(s) 1028 can include any type of display, including, but not limited to, a cathode ray tube (CRT), a liquid crystal display (LCD), a plasma display, etc.

The processor-based system 1000 in FIG. 10 may include a set of instructions 1030 that may be used to provide the functionality, including to control the operation of the power management system 1004. The instructions 1030 may be stored in the system memory 1010, processor 1002, and/or instruction cache 1006 as examples of non-transitory computer-readable medium 1032. The instructions 1030 may also reside, completely or at least partially, within the system memory 1010 and/or within the processor 1002 during their execution. The instructions 1030 may further be transmitted or received over the network 1026 via the modem 1022, such that the network 1026 includes the non-transitory computer-readable medium 1032.

While the non-transitory computer-readable medium 1032 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (RAM), a magnetic disk storage medium, an optical storage medium, flash memory devices, etc.) and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories, registers, or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium, and executed by a processor or other processing device, or combinations of both. The components of the processors and systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be referenced throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations, and variations of the disclosed embodiments incorporating the spirit and substance of the invention may occur to persons skilled in the art, the invention should be construed to include everything within the scope of the appended claims and their equivalents.

What is claimed is:

1. A processor-based system, comprising:
a plurality of processor cores;
a plurality of performance limit registers each associated with an assigned processor core of the plurality of processor cores,
each performance limit register of the plurality of performance limit registers configured to store a performance state limit and a current consumption limit;
a power management circuit configured to, for each processor core of the plurality of processor cores:
determine a local power budget for the processor core based on a system power budget in the processor-based system;
determine a performance state limit and a current consumption limit for the processor core based on a determined local power budget for the processor core; and
write the determined performance state limit and the current consumption limit for the processor core to the performance limit register of the plurality of performance limit registers associated with the processor core;
a plurality of performance control circuits each associated with an assigned processor core of the plurality of processor cores, each performance control circuit of the plurality of performance control circuits configured to:
control a performance state of its assigned processor core according to a current performance state for its assigned processor core;
determine whether the current performance state of its assigned processor core exceeds the performance state limit in the performance limit register for its assigned processor core;
in response to determining that the current performance state of its assigned processor core exceeds the performance state limit in the performance limit register for its assigned processor core:
update the current performance state of its assigned processor core to the performance state limit;
determine whether current consumption of its assigned processor core exceeds the current consumption limit in the performance limit register for its assigned processor core; and
in response to determining that the current consumption of its assigned processor core exceeds the current consumption limit in the performance limit register for its assigned processor core:
throttle the current performance state of its assigned processor core to a new performance state lower than the current performance state.

2. The processor-based system of claim 1, wherein for each processor core of the plurality of processor cores, the power management circuit is configured to write the determined performance state limit and the current consumption limit to the performance limit register associated with the processor core in a single write operation.

3. The processor-based system of claim 1 further comprising a system-on-a-chip (SoC) comprising a semiconductor die;
wherein the semiconductor die comprises the plurality of processor cores, the plurality of performance limit registers, and the plurality of performance control circuits.

4. The processor-based system of claim 1, wherein:
each processor core of the plurality of processor cores is configured to provide its desired performance state to be communicated to the associated performance control circuit;
each performance control circuit of the plurality of performance control circuits is further configured to communicate the desired performance state of its associated processor core to the power management circuit; and
the power management circuit is further configured to, for each processor core of the plurality of processor cores:
determine the local power budget for the processor core based on the system power budget and the desired performance state for the processor core.

5. The processor-based system of claim 1,
wherein each processor core of the plurality of processor cores is configured to operate on a local voltage;
further comprising:
a plurality of local voltage regulators each associated with an assigned processor core of the plurality of processor cores and each configured to receive a supply voltage; and
wherein:
each performance control circuit of the plurality of performance control circuits is configured to control the performance state of its assigned processor core by being configured to:
control a local voltage regulator of the plurality of local voltage regulators of its assigned processor core to generate the local voltage at a voltage level according to the current performance state of its assigned processor core.

6. The processor-based system of claim 1,
wherein each processor core of the plurality of processor cores is configured to operate on a local voltage and a local clock signal;
further comprising:
a plurality of local clock generator circuits each associated with an assigned processor core of the plurality of processor cores and each configured to generate the local clock signal for its assigned processor core;
wherein:
each performance control circuit of the plurality of performance control circuits is configured to control the performance state of its assigned processor core by being configured to:
control a local clock generator circuit of the plurality of local clock generator circuits of its assigned processor core to generate the local clock signal at a frequency according to the current performance state of its assigned processor core.

7. The processor-based system of claim 1,
wherein each processor core of the plurality of processor cores is configured to operate on a local voltage and a local clock signal;
further comprising:
a plurality of local voltage regulators each associated with an assigned processor core of the plurality of processor cores and each configured to receive a supply voltage; and
a plurality of local clock generator circuits each associated with an assigned processor core of the plurality of processor cores and each configured to generate the local clock signal for its assigned processor core;
wherein:
each performance control circuit of the plurality of performance control circuits is configured to control the current performance state of its assigned processor core by being configured to:
control a local voltage regulator of the plurality of local voltage regulators of its assigned processor core to generate the local voltage at a voltage level according to the current performance state of its assigned processor core; and
control a local clock generator circuit of the plurality of local clock generator circuits of its assigned processor core to generate the local clock signal at a frequency according to the current performance state of its assigned processor core.

8. The processor-based system of claim 1, further comprising:
a plurality of current measurement circuits each associated with the assigned processor core of the plurality of processor cores,
each current measurement circuit of the plurality of current measurement circuits configured to generate the current consumption of its assigned processor core.

9. The processor-based system of claim 1, wherein each performance control circuit of the plurality of performance control circuits is further configured to, in response to determining that the current consumption of its assigned processor core exceeds the current consumption limit in the performance limit register:
throttle the current consumption of its assigned processor core.

10. The processor-based system of claim 8, wherein each performance control circuit of the plurality of performance control circuits comprises a current measurement circuit of the plurality of current measurement circuits for its assigned processor core.

11. The processor-based system of claim 1, wherein each performance control circuit of the plurality of performance control circuits is further configured to provide a confirmation of the controlled performance state of its assigned processor core to be communicated to the power management circuit.

12. The processor-based system of claim 11, wherein the power management circuit is further configured to, for each processor core of the plurality of processor cores:
determine the local power budget for the processor core based on the confirmed controlled performance state of the processor core.

13. The processor-based system of claim 1, wherein;
each performance control circuit of the plurality of performance control circuits is further configured to provide a priority level to be communicated to the power management circuit; and
the power management circuit is further configured to, for each processor core of the plurality of processor cores:
determine the local power budget for the processor core based on the priority level of the processor core.

14. The processor-based system of claim 5, wherein:
each performance control circuit of the plurality of performance control circuits is further configured to provide a confirmation of the controlled performance state of its assigned processor core to be communicated to the power management circuit; and
the power management circuit is further configured to lower the supply voltage based on the confirmed controlled performance state for each processor core of the plurality of processor cores.

15. A method of managing power consumption of a plurality of processor cores in a processor in a processor-based system, comprising:
for each processor core of the plurality of processor cores:
determining a local power budget for the processor core based on a system power budget in the processor-based system;
determining a performance state limit and a current consumption limit for the processor core based on a determined local power budget for the processor core;
writing the determined performance state limit and the current consumption limit for the processor core to a performance limit register of a plurality of performance limit registers associated with the processor core;
controlling a performance state of the processor core according to a current performance state for the processor core;
determining whether the current performance state of the processor core exceeds the performance state limit in the performance limit register for the processor core;
in response to determining that the current performance state of the processor core exceeds the performance state limit in the performance limit register for the processor core:
updating the current performance state of the processor core to the performance state limit;
determining whether current consumption of the processor core exceeds the current consumption limit in the performance limit register associated with the processor core; and
in response to determining that the current consumption of the processor core exceeds the current consumption limit in the performance limit register associated with the processor core:
throttling the current performance state of the processor core to a new performance state lower than the current performance state.

16. The method of claim 15, comprising writing the determined performance state limit and the current consumption limit to the performance limit register associated with the processor core in a single write operation.

17. The method of claim 15, further comprising:
each processor core of the plurality of processor cores providing its desired performance state to be communicated to the associated performance control circuit;
communicating the desired performance state of its associated processor core to the power management circuit; and
for each processor core of the plurality of processor cores:
determining the local power budget for the processor core based on the system power budget and the desired performance state for the processor core.

18. The method of claim 15, further comprising for each processor core of the plurality of processor cores, in response to determining that the current consumption of its assigned processor core exceeds the current consumption limit in the performance limit register:
throttling the current consumption of its assigned processor core.

19. The method of claim 15, further comprising, for each processor core of the plurality of processor cores:
providing a priority level for the processor core; and
determining the local power budget for the processor core based on the priority level of the processor core.

20. A non-transitory computer-readable medium having stored thereon computer executable instructions, which when executed by a processor in a processor-based system comprising a plurality of processor cores, cause the processor to:
for each processor core of the plurality of processor cores:
determine a local power budget for the processor core based on a system power budget in the processor-based system;
determine a performance state limit and a current consumption limit for the processor core based on a determined local power budget for the processor core;
write the determined performance state limit and the current consumption limit for the processor core to a performance limit register of a plurality of performance limit registers associated with the processor core;
control a performance state of the processor core according to a current performance state for the processor core;
determine whether the current performance state of the processor core exceeds the performance state limit in the performance limit register for the processor core;
in response to determining that the current performance state of the processor core exceeds the performance state limit in the performance limit register for the processor core:
update the current performance state of the processor core to the performance state limit;
determine whether current consumption of the processor core exceeds the current consumption limit in the performance limit register associated with the processor core; and
in response to determining that the current consumption of the processor core exceeds the current consumption limit in the performance limit register associated with the processor core:
throttle the current performance state of the processor core to a new performance state lower than the current performance state.
